(19) United States
(12) Patent Application Publication
(10) Pub. No.: US 2018/0015764 A1
(43) Pub. Date: Jan. 18, 2018

(54) PRE-TREATMENT COMPOSITION

(71) Applicant: Hewlett-Packard Development Company, L.P., Houston, TX (US)

(72) Inventors: Xiaoqi Zhou, San Diego, CA (US); Xulong Fu, San Diego, CA (US)

(21) Appl. No.: 15/545,710

(22) PCT Filed: Feb. 13, 2015
(86) PCT No.: PCT/US2015/015928

§ 371 Date: Jul. 23, 2017

(51) Int. Cl. B41M 5/52; C09D 129/04; C09D 7/12

(52) U.S. Cl. CPC B41M 5/5218; C09D 7/1216; C09D 129/04

(57) ABSTRACT

Disclosed herein is a pre-treatment composition that includes aggregated nano-sized inorganic pigment particles, polymeric organic particles having a particle size in a ratio of 100:1 to 1000:1 by comparison with the size of aggregated nano-sized inorganic pigment particles, an ink absorber and a polymeric binder. Also disclosed herein is a printable media that includes a media substrate and the pre-treatment composition which is applied to, at least, one side of the substrate; and the method for obtaining it.

### BACKGROUND

Inkjet printing is a non-impact printing method in which an electronic signal controls and directs droplets or a stream of ink that can be deposited on a variety of substrates. Current inkjet printing technology involves forcing the ink drops through small nozzles by thermal ejection, piezoelectric pressure or oscillation, onto the surface of a media. This technology has become a popular way of recording images on various media surfaces, particularly paper, for a number of reasons, including low printer noise, capability of high-speed recording and multi-color recording. Inkjet web printing is a technology that is specifically well adapted for commercial and industrial printing. Example of such printing technology is the “HP Page Wide Array printing” where more than hundreds of thousand tiny nozzles on a stationary print-head that spans the width of a page, delivering multi-colors ink onto a moving sheet of paper under a single pass to achieve the super-fast printing speed.

With these printing technologies, it is apparent that the image quality of printed images is strongly dependent on the construction of the recording media used. Pre-treatment compositions or coatings can likewise be applied to various media to improve printing characteristics and attributes of an image.

### BRIEF DESCRIPTION OF THE DRAWINGS

The drawings illustrate various embodiments of the present recording media and are part of the specification.

FIGS. 1 and 2 are cross-sectional views of the printable recording media according to embodiments of the present disclosure.

FIG. 3 is a flow chart of a method for making a printable recording media in accordance with an example of the present disclosure.

### DETAILED DESCRIPTION

The present disclosure refers to a pre-treatment composition comprising aggregated nano-sized inorganic pigment particles, polymeric organic particles having particles size in a ratio of 100:1 to 1000:1 by comparison with the size of aggregated nano-sized inorganic pigment particles, an ink absorber and a polymeric binder. The present disclosure refers also to a printable recording media comprising a media substrate and the pre-treatment composition as defined herein which is applied to, at least, one side of the substrate in order to form a coated printable recording media. The present disclosure refers also to the method for obtaining it.

Before particular embodiments of the present disclosure are disclosed and described, it is to be understood that the present disclosure is not limited to the particular process and materials disclosed herein. It is also to be understood that the terminology used herein is used for describing particular embodiments only and is not intended to be limiting, as the scope of protection will be defined by the claims and equivalents thereof. In describing and claiming the present article and method, the following terminology will be used: the singular forms “a”, “an”, and “the” include plural referents unless the context clearly dictates otherwise. Concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a weight range of about 1 wt % to about 20 wt % should be interpreted to include not only the explicitly recited concentration limits of 1 wt % to 20 wt %, but also to include individual concentrations such as 2 wt %, 3 wt %, 4 wt %, and sub-ranges such as 5 wt % to 15 wt %, 10 wt % to 20 wt %, etc. All percent are by weight (wt %) unless otherwise indicated. As used herein, “image” refers to marks, signs, symbols, figures, indications, and/or appearances deposited upon a material or substrate with either visible or an invisible ink composition. Examples of an image can include characters, words, numbers, alphanumeric symbols, punctuation, text, lines, underlines, highlights, and the like.

The present disclosure refers to a pre-treatment composition. Such pre-treatment composition, or treatment composition, can be considered as a coating composition since it can be applied to various media to improve, for example, printing characteristics and attributes of an image. The phrase “pre-treatment” refers to the process to apply a composition to a printable recording media prior to printing application. In some examples, the pre-treatment composition is a pre-treatment composition that is going to be applied to an uncoated printable recording media. By “uncoated”, it is meant herein that the printable recording media has not been treated or coated by any composition after paper web is formed and dried at a paper machine. Alternatively, “uncoated” also refers to the paper web which is formed and dried on a paper machine and that is then treated with a starch based solution known as “surface treatment or sizing” at a paper machine. In some examples, the pre-treatment composition is a pre-treatment composition that is going to be applied to a coated printable recording media. By “coated”, it is meant herein that the printable recording media has been applied a composition prior to apply a “pre-treatment” composition. It is noted that the term “pre-treatment composition” refers to either a composition used to form a coating layer as well as the coating layer itself, the context dictating which is applicable. For example, a pre-treatment composition or coating that includes an evaporable solvent is referring to the compositional coating that is applied to a media substrate. Once coated on a media substrate and after the evaporable solvent is removed, the resulting coating layer can also be referred to as a pre-treatment coating.

In some examples, the printable recording media, on which the treatment composition will be applied, is an inkjet printable media that comprise a substrate. The substrate can be specifically designed to receive any inkjet printable ink, such as, for example, organic solvent-based inkjet inks or aqueous-based inkjet inks Examples of inkjet inks that may be deposited, established, or otherwise printed on the printable substrate, include pigment-based inkjet inks, dye-based inkjet inks, pigmented latex-based inkjet inks and UV curable inkjet inks

The pre-treatment composition can be substantially colorless and can be formulated to interact with the colorant and/or with polymeric components of certain ink compositions. With the use of such pre-treatment compositions, precipitated colorants deposited on the surface of recording media can provide enhancement of image quality. For example, improved optical density, improved durability and high speed printing may be achieved with such pre-treatment compositions. Alternatively, the pre-treatment composition can be colored. Such colored pre-treatment composition can create some special colored printing media such as blue drawing paper used engineering design and drawing.

In some examples, the pre-treatment composition, when applied to a printable recording media, will provide printed images and articles that demonstrate excellent image quality (good bleed and coalescence performance) while enabling high-speed and very high-speed printing. By high-speed printing, it is meant herein that the printing method can have a speed of 50 to 800 m/min or higher (such as HP Web Press printers).

In some other examples, the pre-treatment composition, when applied to printable recording media, provides printed images that have, in the same time, an excellent gloss and a high absorptivity. The images printed on the recording media are able to impart excellent image quality: provides vivid color, such as higher gamut and have a high degree of gloss, and high color density. High print density and color gamut volume are realized with substantially no visual color-to-color bleed and with good coalescence characteristics. The pre-treatment composition, when applied to printable recording media, provides printed images that have also excellent durability.

In yet some other examples, the pre-treatment composition, when applied to printable recording media, provides printed article and image that have good dry time and fast absorption rate. By “fast absorption rate”, it is meant that the water, solvent and/or vehicle of the ink can be absorbed by the media at a fast rate so that the ink composition does not have a chance to interact and cause bleed and/or coalescence issues. The absorption rate that defects free printing is dependent on the speed of the printing and amount of ink being used. The faster the printing speed and the higher the amount of ink used, the higher is the demand on faster absorption from the media.

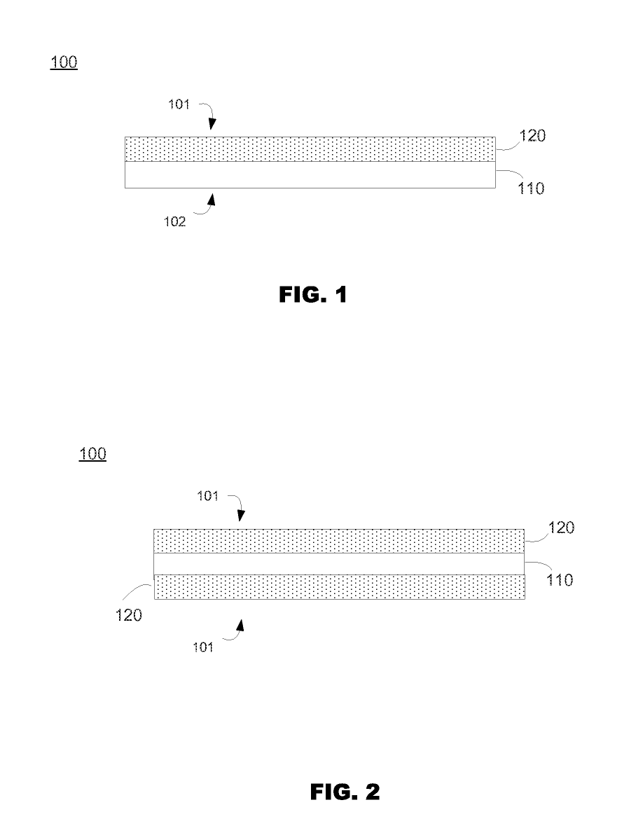

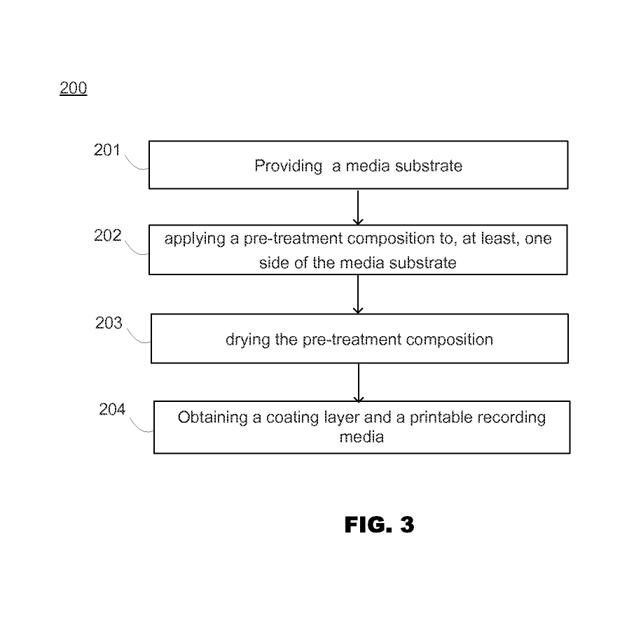

FIG. 1 illustrates the printable recording media (100) as described herein. The printable media (100) encompasses a base substrate or media substrate or bottom supporting substrate (110) and a coating layer (120) that result from the application of the pre-treatment composition as described herein. The pre-treatment composition is applied on, at least, one side of the substrate (110) in order to from the coating layer (120). The pre-treatment composition is thus applied on one side, i.e. the image side (101), only and no other coating is applied on opposite side (102). In some other examples, such as illustrated in FIG. 2, the pre-treatment composition is applied to both opposing sides of the substrate. The double-side coated media has thus a sandwich structure, i.e. both sides of the substrate (110) are coated and both sides may be printed. If the coated side is used as an image-receiving side (101), the other side, i.e. backside (102), may not have any coating at all, or may be coated with other chemicals (e.g. sizing agents) or coatings to meet certain features such as to balance the curl of the final product or to improve sheet feeding in printer. FIG. 3 is a flow chart of a method for making a printable recording media, where the pre-treatment composition of the present disclosure is applied to a media substrate in order to produce printable recording media in accordance with an example of the present disclosure

The pre-treatment composition that is used to form the coating layer (120) includes aggregated nano-sized inorganic pigment particles, polymeric organic particles having particles size in a ratio of 100:1 to 1000:1 by comparison with the size of aggregated nano-sized inorganic pigment particles, an ink absorber and a polymeric binder. In some examples, the pre-treatment composition further comprises an inorganic spacer. The printable media or printable recording media (100) comprises thus a media substrate (110) and a pre-treatment composition or coating applied thereon, on at least one side of the substrate, in order to form a printable media, the pre-treatment composition comprising aggregated nano-sized inorganic pigment particles, polymeric organic particles having particles size in a ratio of 100:1 to 1000:1 by comparison with the size of aggregated nano-sized inorganic pigment particles, an ink absorber and a polymeric binder.

The pre-treatment composition comprises aggregated nano-sized pigment particles. In some examples, the aggregated nano-sized pigment particles are synthetic aggregated nano-sized pigment particles. The word “synthetic” refers to small particles that do not come from mechanical milling of mineral, rather from a chemical precipitate procedure to generate nano-scale particles. In some other examples, the aggregated nano-sized pigment particles are nano-sized inorganic pigment particles. By “inorganic particle”, it is meant herein any particle which does not chemically contain carbon or which contains carbon, where applicable, in the form of carbonate or cyanide. The pigment particles are nano-particles, which means that they are “nano-sized” (nanometer-sized) pigment particles. The nano-sized pigment particles are in the form of single particles that have an average particle size in the nanometer range. However, due to Brownian motion (or Pedesis motion), single particles are able to collision with each other to form primary aggregated particles that have an average particle size in the nanometer size (nm, 10⁻⁹ meter). The nano-sized inorganic pigment particles are thus considered as aggregated nano-sized inorganic pigment particles. By “aggregated”, it is meant herein that the inorganic pigment particles have an agglomeration structure: the particles are aggregated and formed “primary aggregated particles”. These primary aggregated particles can further come together in order to form an aggregated particle gel. The status of primary aggregated particles can be achieved by chemical dispersion along with mechanical dispersion. In some examples, the primary aggregated inorganic nano-particles partially aggregate to form a “particle gel” (or aggregated particle gel) have with average aggregated size of 20 to 100 nanometers (nm, 10⁻⁹ m). The primary aggregated particles gel can have a special structure where many tiny holes are formed during aggregation so that a nano-scale porous particle is formed. The morphology of the aggregated primary particle gel can be in any geometrical form such as spherical; rod-like, plate-like, cubic, ellipsoid or other particle shapes. In some examples, the aggregated particles are considered as substantially spherical.

In some examples, the aggregated nano-sized inorganic pigment particles have an average particle size in the range of about 1 to about 500 nanometer (nm). In some other examples, the aggregated nano-sized inorganic pigment particles have an average particle size in the range of about 2 to about 300 nanometer (nm). The aggregated particle can also have a size in the range of about 20 to 100 nm as measured using laser diffraction spectroscopy but avoiding larger percentage of un-aggregated particles which have the size of 0.1 to 1 nm as measured by using x-ray diffractometer.

The surface area of the aggregated inorganic pigment particles can be in the range of about 20 to about 800 square meter per gram or in the range of about 25 to about 350 square meter per gram (gsm). The surface area can be measured, for example, by adsorption using BET isotherm.

In some examples, the inorganic pigment particles are pre-dispersed chemically in an acidic condition coupling with mechanical mixing in a dispersed slurry form before being mixed with the composition for coating on the substrate. An alumina aggregate powder can be dispersed, for example, with high share rotor-stator type dispersion system such as an Ystral system under specific acidic condition.

In some examples, the pre-treatment composition contains from about 10 wt % to about 95 wt % of aggregated nano-sized inorganic pigment particles by total weight of the pre-treatment composition. In some other examples, the pre-treatment composition contains from about 40 wt % to about 85 wt % of aggregated nano-sized inorganic pigment particles by total weight of the pre-treatment composition.

In some examples, the nano-sized inorganic pigment particles are metal oxide or complex metal oxide particles. As used herein, the term “metal oxide particles” encompasses metal oxide particles or insoluble metal salt particles. Metal oxide particles are particles that have high refractive index (i.e. more than 1.65) and that have particle size in the nano-range such that they are substantially transparent to the naked eye. The visible wavelength is ranging from about 400 to about 700 nm.

In some examples, the nano-sized inorganic pigment particles are pseudo-boehmite, which is aluminum oxide/hydroxide (Al₂O₃ₙH₂O where n is from 1 to 1.5). In some other examples, the nano-sized inorganic pigment particles are metal oxide or semi-metal oxide that can include alumina which comprises rare earth-modified boehmite, such as those selected from lanthanum, ytterbium, cerium, neodymium, praseodymium, and mixtures thereof. Commercially available alumina particles can also be used and include, but not limited to, Sasol Disperal® HP10, boehmite, and Cabot SpectrAl® 80 fumed alumina.

Examples of nano-sized inorganic pigment particles also include, but are not limited to, titanium dioxide, hydrated alumina, calcium carbonate, barium sulfate, silica, high brightness alumina silicates, boehmite, pseudo-boehmite, zinc oxide, kaolin clays, and/or their combination. The inorganic pigment can include clay or a clay mixture. The inorganic pigment filler can include a calcium carbonate or a calcium carbonate mixture. The calcium carbonate may be one or more of ground calcium carbonate (GCC), precipitated calcium carbonate (PCC), modified GCC, and modified PCC. The inorganic particles that can also be selected from the group consisting of aluminum oxide (Al₂O₃), silicon dioxide (SiO₂), nanocrystalline boehmite alumina (AlO(OH)) and aluminum phosphate(AlPO₄). In some other examples, the inorganic particles are aluminum oxide (Al₂O₃) or silicon dioxide (SiO₂). Examples of such inorganic particles are Disperal®HP-14, Disperal® HP-16 and Disperal® HP-18 available from Sasol Co. The nano-sized inorganic pigment particles can also be silica or fumed silica particles. Examples of commercially available fumed silica include Cab-O-SirLM-150, Cab-O-Sil®M-5, Cab-O-Sil®MS-55, Cab-O-Sil®MS-75D, Cab-O-Sil®H-5, Cab-O-Sil®HS-5, Cab-O-Sil®EH-5, Aerosil® 150, Aerosil® 200, Aerosil® 300, Aerosil® 350 and Aerosil® 400.

In some examples, the nano-sized inorganic pigment particles of the pre-treatment composition are titanium dioxide (TiO₂), aluminum oxide (Al₂O₃) or silicon dioxide (SiO₂). In some other examples, the nano-sized inorganic pigment particles can have a chemical composition of Si₄Mg₃O₁₀(OH)₂, such as those commercially available under the trademark Laponite® (from Southern Clay Products, Gonzales, Tex., USA) or Optigel® SH (from Sud-Chemie; Louisville, Ky.).

The aggregate nano-sized inorganic pigment particles could also be a “colloidal solution” or “colloidal sol”. Said colloidal sol is a composition that nano-sized particles with metal oxide structure such as aluminum oxide, silicon oxide, zirconium oxide, titanium oxide, calcium oxide, magnesium oxide, barium oxide, zinc oxide, boron oxide, and mixture of two or more metal oxide. In some examples, such as the colloidal sol is a mixture of about 10 to 20 wt % of aluminum oxide and about 80 to 90 wt % of silicon oxide. In some examples, such as the colloidal sol is a mixture of about 14 wt % of aluminum oxide and about 86 wt % of silicon oxide. The aggregate nano-sized inorganic pigment particles can be, in the aqueous solvent, either cationically or anionically charged and stabilized by various opposite charged groups such as chloride, sodium ammonium and acetate ions. Examples of colloidal sol are commercial available under the tradename Nalco®8676, Nalco®1056, Nalco 1057, as supplier by NALCO Chemical Company; or under the name Ludox®/Syton® such as Ludox® HS40 and HS30, TM/SM/AM/AS/LS/SK/CL-X and Ludox® TMA from Grace Inc.; or under the name Ultra-Sol 201A-280/140/60 from Eminess Technologies Inc. The colloidal sol can also be prepared by using particles agglomerates which have the chemical structure as descripted above but which have starting particles size in the range of about 5 to 10 micrometer (10⁻⁶ meters). Such colloidal sol can be obtained by breaking agglomerates using chemical separation and mechanical shear force energy. Monovalent acids such as nitric, hydrochloric, formic or acetic with a PKa value of 4.0 to 5.0 can be used. Agglomerates are commercial available, for example, from Sasol, Germany under the tradename of Disperal® or from Dequenne Chimie, Belgium under the Dequadis®HP.

The aggregate nano-sized inorganic pigment particles can be treated with acetic acid in order to adjust the pH to the range 3.5 to 5.5, and can then be dispersed using high share Rotor-stator system such as Kadi®mill or Ystral® system.

The primary aggregated inorganic pigment particles can be modified into synthetic organic-inorganic particles, meaning that synthetic inorganic particles can be underwent a surface treatment with organic compounds with functional groups. The inorganic nanoparticles may also be surface modified, depending on the particular type of composition involved and stability requirement. In some examples, the organic compound with functional groups are organosilanes. Organosilane can be represented by the general formula Y—R—Si—X₃ where X is a hydrolysable alkoxy group such as methoxy and ethoxy, and Y is an organo-functional group such as amino, vinyl, expoxy-methacryl. The group Y is connected with silicon via an alkyl bridge as represented by R in the formula. In a neutral to acidic environment, the X group and the alkoxy groups are able to react with the surface groups of inorganic fillers. The reaction is firstly hydrolization to generate silane triol, and silanol groups then condense with oxide or hydroxyl group on the filler surface. The neighboring siloxane chains can interact further to eventually form a polysiloxane layer at the particle surface.

Examples of organosilane include gamma-amino-propyl-triethoxy silane, mono-amino silane, diamino silane, triamino silane, bis(2-hydroethyl)-3-amino-propyl-triethoxysilane, 3-mercapto-propyl-trimethoxysilane, 3-glycidoxy-propyl-trimethoxysilane, bis(triethoxy-silylpropyl)disulfide, 3-amino-propyl-triethoxysilane, bis-(trimethoxy-silyl-propyl)amine, N-phenyl-3-aminopropyltrimethoxysilane, N-aminoethyl-3-aminopropylmethyldimethoxysilane, 3 -ureido-propyl-trimethoxysilane, 3 -methacryl-oxypropyl-trimethoxysilane, N-(trimethyl-oxy-silylpropyl)isothiouronium chloride, N-(triethoxy-silpropyl)-O-polyethylene oxide, 3-(triethoxy-silyl-propyl succinic anhydride, or 3-(2-imidazolin-1-yl)propyl-tri-ethoxy-silane, 3-aminopropyltrimethoxysilane, N-(2-aminoethyl-3-aminopropyltrimethoxysilane, 3-(triethoxy-silylpropyl)-diethylenetriamine, poly(ethyleneimine)trimethoxysilane, amino-ethylamino-propyl trimethoxysilane, or amino-ethylamino-ethyl-amino-propyl trimethoxysilane.

The aggregated nano-sized inorganic pigment particles can be also modified with inorganic surface treatment compounds and/or with organic compounds with functional groups. An example of inorganic treatment compounds includes aluminum chlorohydrate. The organosilane reagent can be reacted with aluminum chlorohydrate. In some examples, the aggregated nano-sized inorganic pigment particles are modified with a surface treatment containing organosilane and aluminum chlorohydrate.

The organosilane and the aluminum chlorohydrate can function together to treat the metal oxide or semi-metal oxide, e.g. fumed silica, from being negatively charged to being cationically charged. It has been recognized that good printing results, as well as good adhesion can be obtained when aluminum chlorohydrate (ACH) is reacted with aminosilane coupling agent first in an aqueous medium to form a complex of sorts. In one preparatory example, such “complex” is believed to be formed by a covalent bonding with the surface of aggregated nano-sized inorganic pigment particles, and the powder of aggregated nano-sized inorganic pigment particles can then be dispersed into an aqueous solution comprising the adduct of aluminum chlorohydrate and an aminosilane. When included, the aluminum chlorohydrate can be reacted with the organosilane reagent at a weight ratio of aluminum chlorohydrate to organosilane of 1:10 to 5:1.

The pre-treatment composition may further, optionally, comprise inorganic spacers. In some examples, the inorganic spacer is part (i.e. included) of the aggregated nano-sized inorganic pigment particle system. Thus, with regard to aggregate nano-sized inorganic pigment particles, the pre-treatment composition may further include second particles (i.e. inorganic spacer) that have a size range that is at least 5 times bigger than the size of the first nano-particles (i.e. aggregate nano-sized inorganic pigment particles). Without being linked by any theory, it is believe that with addition of small amount of inorganic spacers, the direct collision of the aggregate nano-sized inorganic pigment particles will be reduced and therefore the stability and particle size of inorganic particles can be controlled. The inorganic spacer particles can be thus added in order to improve the stability of the dispersion of the aggregate nano-sized inorganic pigment particles.

The inorganic spacers are particles that have larger particle size compared with aggregated nano-sized inorganic pigment particles, with a ratio of 5:1 to 200:1 (by comparison with the size of aggregated nano-sized inorganic pigment particles). Which means that, in some examples, the inorganic spacers are particles that have an average particle size in the range of about 0.1 to about 25 micrometers (um, 10⁻⁶m). In some other examples, the inorganic spacers are particles that have an average particle size in the range of about 1 to about 10 micrometers (μm). In some examples, the ratio, by weight, of inorganic spacer compared with aggregated nano-sized inorganic pigment particles ranges from 1:300 to 1:1500.

Examples of inorganic spacers include but are not limited to, calcium carbonate, zeolite, silica, talc, alumina, aluminum trihydrate (ATH), calcium silicate, kaolin, calcined clay, and combination or mixtures of any of these. Examples of inorganic spacer particles, also includes, but are not limited to, ground calcium carbonate such as Hydrocarb® 60 available from Omya, Inc.; precipitated calcium carbonate such as Opacarb®A40 or Opacarb®3000 available from Specialty Minerals Inc. (SMI); clay such as Miragloss® available from Engelhard Corporation; synthetic clay such as hydrous sodium lithium magnesium silicate, such as, for example, Laponite® available from Southern Clay Products Inc., and titanium dioxide (TiO₂) available from, for example, Sigma-Aldrich Co. Examples of inorganic spacer particles include, but are not limited to, particles, either existing in a dispersed slurry or in a solid powder, of polystyrene and its copolymers, polymethacrylates and their copolymers, polyacrylates and their copolymers, polyolefins and their copolymers, such as polyethylene and polypropylene, a combination of two or more of the polymers. The inorganic spacer particles may be chosen from silica gel (e.g., Silojet®703C available from Grace Co.), modified (e.g., surface modified, chemically modified, etc.) calcium carbonate (e.g., Omyajet®B6606, C3301, and 5010, all of which are available from Omya, Inc.), precipitated calcium carbonate (e.g., Jetcoat®30 available from Specialty Minerals, Inc.), and combinations thereof.

The pre-treatment composition comprises polymeric organic particles. By “organic particle”, it is meant herein that a particle that has natural and synthetic compounds of high molecular weight consisting of hydrogen-carbon back bone chain structure such as linear polyethylene, polypropylene and cyclic polystyrene. By “polymeric”, it is meant herein that the organic particles can be in any polymeric bond chain structure for example, polyolefin like polyethylene and copolymers, polypropylene and copolymers, poly-wax, poly-paraffin, polyacrylic and copolymers, polymethacrylic and copolymers, polystyrene and copolymers, polyurethanes and copolymers.

In some examples, the polymeric organic particles have a size, compared to the size of the aggregated nano-sized inorganic pigment particles, in a ratio of 100:1 to 1000:1. Thus, in some examples, the average particle size of the polymeric organic particle is from about 0.1 μm to about 50 μm; in some other examples, from about 0.5 μm to about 10 μm; in yet some other examples, from about 1 μm to about 5 μm.

In some examples, the polymeric organic particles are present in the pre-treatment composition in an amount representing from about 5 to about 20 parts based on 100 parts of aggregated nano-sized inorganic pigment particles.

The polymeric organic particles can be present, in the pre-treatment composition, under any morphology such as solid particles or hollow particles, or particles with core-shell structure. The electric charge of the particles can be any kind but in some examples, they are positively charged or non-ionic charged.

The polymeric organic particles may have an average molecular weight (Mw) of about 5,000 to about 500,000. In some examples, the polymeric organic particles have an average molecular weight (Mw) ranging from about 100,000 to about 300,000. In some other examples, the polymeric organic particles have an average molecular weight of about 250,000.

In some examples, the polymeric organic particles are polyolefin particles, dispersion or emulsion of polyolefin particles, acrylic emulsion or polyacrylic emulsion. The polymeric organic particles can be polyolefin particles or dispersion or emulsion of polyolefin particles such as polyethylene and polypropylene particles such as the ones commercial available from BYK Ltd with tradename of Polyemulsion10A30®, polyemulsion10G38SP®, polyemulsion10N40® and Polyemulsion316G30SP®; Luwax® or Poligen® serials wax from BASF; and Ultralube® serials wax from Keim-Additec Co. The polymeric organic particles can also be acrylic emulsion or polyacrylic emulsion. The polymeric organic particles can be chosen among the group consisting of styrene, acrylic, styrene/acrylics, vinyl/acetate, polyacrylics, methacrylates and combinations thereof. In some examples, the polymeric organic particles can be polystyrene latex polymers. In some other examples, the polymeric organic particles are plastic pigment slurry of styrene/butadiene emulsion copolymers. Examples of polymeric organic particles that can be used in accordance with embodiments of the present invention include Ropaque®BC-643, Ropaque®HP-543, or Ropaque®OP-84 (all manufactured by Rohm and Haas Company, USA) and HS-3000NA or HS-3020NA (available from The Dow Chemical Company, USA). Other specific examples of these polymers may include, a styrene acrylic emulsion polymer sold under the trade name Raycat® 29033, a polyacrylic emulsion polymer sold under the trade name Raycat®78, and an acrylic emulsion polymer sold under the trade name Raycryl® 30S available from Specialty Polymers, Inc.

The pre-treatment composition comprises an ink absorber. The ink absorber can be present, in the pre-treatment composition, in an amount representing from about 0.05 to about 5 dry parts based on 100 parts of aggregated nano-sized inorganic pigment particles.

Without being linked by any theory, it is believed that the function of the ink absorber is to be able to separate the colorant (pigment or dye) contained in the ink composition from ink vehicle of the ink composition applied to the printable media and then chemical bonding the ink pigment or dye. The ink absorber can be considered as an “electrical charged” compound. “Electrical charged” refers to chemical substance with some atoms gaining or losing one or more electrons or protons, together with a complex ion consists of an aggregate of atoms with opposite charge. The electrical charged substance is a charged ion or associated complex ion that can de-coupled in an aqueous environment. In some examples, the electrical charged substance is an electrolyte, having a low molecular species or a high molecular species.

In some examples, the ink absorber is a water soluble salt. The term “water soluble” is meant to be understood broadly as a species that is readily dissolved in water. Thus, water soluble salts may refer to a salt that has a solubility greater than 15 g/100 g H₂O at 1 Atm. pressure and at 200° C. The electrical charged substance can be a water soluble metallic salt that can be an organic salt or an inorganic salt. The electrical charged substance can be an inorganic salt; in some examples, the electrical charged substance is a water-soluble and multi-valent charged salts. Multi-valent charged salts include cations, such as Group I metals, Group II metals, Group III metals, or transition metals, such as sodium, calcium, copper, nickel, magnesium, zinc, barium, iron, aluminum and chromium ions. The associated complex ion can be chloride, iodide, bromide, nitrate, sulfate, sulfite, phosphate, chlorate, acetate ions.

The ink absorber can be an organic salt; in some examples, the ink absorber is a water-soluble organic salt. Organic salt refers to associated complex ion that is an organic species, where cations may or may not the same as inorganic salt like metallic cations. Organic metallic salt are ionic compounds composed of cations and anions with a formula such as (CₙH₂ₙ₊₁COO⁻M⁺)*(H₂O)ₘ where M⁺ is cation species including Group I metals, Group II metals, Group III metals and transition metals such as, for example, sodium, potassium, calcium, copper, nickel, zinc, magnesium, barium, iron, aluminum and chromium ions. Anion species can include any negatively charged carbon species with a value of n from 1 to 35. The hydrates (H₂O) are water molecules attached to salt molecules with a value of m from 0 to 20. Examples of water soluble organic salts include metallic acetate, metallic propionate, metallic formate, metallic oxalate, and the like. The organic salt may include a water dispersible organic salt. Examples of water dispersible organic salts include a metallic citrate, metallic oleate, metallic oxalate, and the like.

In some examples, the ink absorber is a water soluble, divalent or multi-valent metal salt. Specific examples of the divalent or multi-valent metal salt used include, but are not limited to, calcium chloride, calcium acetate, calcium nitrate, calcium pantothenate, magnesium chloride, magnesium acetate, magnesium nitrate, magnesium sulfate, barium chloride, barium nitrate, zinc chloride, zinc nitrate, aluminum chloride, aluminum hydroxychloride, and aluminum nitrate. Divalent or multi-valent metal salt might also include CaCl₂, MgCl₂, MgSO₄, Ca(NO₃)₂, and Mg(NO₃)₂, including hydrated versions of these salts. In some examples, the water soluble divalent or multi-valent metal salt can be selected from the group consisting of calcium acetate, calcium acetate hydrate, calcium acetate monohydrate, magnesium acetate, magnesium acetate tetrahydrate, calcium propionate, calcium propionate hydrate, calcium gluconate monohydrate, calcium formate and combinations thereof. In some examples, the ink absorber is calcium chloride and/or calcium acetate. In some other examples, the ink absorber is calcium chloride. In some examples, the ink absorber is a high molecular charged substance that includes, but that is not limited, polyaluminum chloride, polyaluminum chlorosulphate, polyaluminum silicosulphate, polydiallyldimethylammonium chloride, quaternary polyamines, poly(styrenesulfonic acid) and dicyandiamide resins.

In some examples, the ink absorber can co-exist with other components in the pre-treatment composition. The pre-treatment layer or coating layer can, therefore, exist as the single layer on the outmost side of the supporting substrate. In some other examples, multiple layers exist on the treatment/coating structure. In some examples, a treatment/coating structure can include a separated ink absorber layer that is sandwiched between the substrate and main composite of the pre-treatment composition. In some other examples, the ink absorber can create a separate layer that is on the top of the pre-treatment composite, i.e. outmost of the printing media.

The pre-treatment composition comprises a polymeric binder. The polymeric binder can be present, in the pre-treatment composition, in an amount representing from about 2 to about 25 dry parts based on 100 parts of aggregated nano-sized inorganic pigment particles.

The polymeric binder can be either water a soluble, a synthetic or a natural substances or an aqueous dispersible substance like polymeric latex. In some other examples, the polymeric binder is polymeric latex. The polymeric binder can be a water soluble polymer or water dispersible polymeric latex. The binder may be selected from the group consisting of water-soluble binders and water dispersible polymers that exhibit high binding power for base paper stock and pigments, either alone or as a combination. In some examples, the polymeric binder components have a glass transition temperature (Tg) ranging from −10° C. to +50° C. The way of measuring the glass transition temperature (Tg) parameter is described in, for example, Polymer Handbook, 3rd Edition, authored by J. Brandrup, edited by E. H. Immergut, Wiley-Interscience, 1989.

Suitable polymeric binder include, but are not limited to, water soluble polymers such as polyvinyl alcohol, starch derivatives, gelatin, cellulose derivatives, acrylamide polymers, and water dispersible polymers such as acrylic polymers or copolymers, vinyl acetate latex, polyesters, vinylidene chloride latex, styrene-butadiene or acrylonitrile-butadiene copolymers. Non-limitative examples of suitable binders include styrene butadiene copolymer, polyacrylates, polyvinylacetates, polyacrylic acids, polyesters, polyvinyl alcohol, polystyrene, polymethacrylates, polyacrylic esters, polymethacrylic esters, polyurethanes, copolymers thereof, and combinations thereof. In some examples, the binder is a polymer and copolymer selected from the group consisting of acrylic polymers or copolymers, vinyl acetate polymers or copolymers, polyester polymers or copolymers, vinylidene chloride polymers or copolymers, butadiene polymers or copolymers, styrene-butadiene polymers or copolymers, acrylonitrile-butadiene polymers or copolymers. In some other examples, the binder component is a latex containing particles of a vinyl acetate-based polymer, an acrylic polymer, a styrene polymer, an SBR-based polymer, a polyester-based polymer, a vinyl chloride-based polymer, or the like. In yet some other examples, the binder is a polymer or a copolymer selected from the group consisting of acrylic polymers, vinyl-acrylic copolymers and acrylic-polyurethane copolymers. Such binders can be polyvinylalcohol or copolymer of vinylpyrrolidone. The copolymer of vinylpyrrolidone can include various other copolymerized monomers, such as methyl acrylates, methyl methacrylate, ethyl acrylate, hydroxyethyl acrylate, hydroxyethyl methacrylate, ethylene, vinylacetates, vinylimidazole, vinylpyridine, vinylcaprolactams, methyl vinylether, maleic anhydride, vinylamides, vinylchloride, vinylidene chloride, dimethylaminoethyl methacrylate, acrylamide, methacrylamide, acrylonitrile, styrene, acrylic acid, sodium vinylsulfonate, vinylpropionate, and methyl vinylketone, etc. Examples of binders include, but are not limited to, polyvinyl alcohols and water-soluble copolymers thereof, e.g., copolymers of polyvinyl alcohol and poly(ethylene oxide) or copolymers of polyvinyl alcohol and polyvinylamine; cationic polyvinyl alcohols; aceto-acetylated polyvinyl alcohols; polyvinyl acetates; polyvinyl pyrrolidones including copolymers of polyvinyl pyrrolidone and polyvinyl acetate; gelatin; silyl-modified polyvinyl alcohol; styrene-butadiene copolymer; acrylic polymer latexes; ethylene-vinyl acetate copolymers; polyurethane resin; polyester resin; and combination thereof. Examples of binders include Poval®235, Mowiol®56-88, Mowiol®40-88 (products of Kuraray and Clariant).

The polymeric binder may have an average molecular weight (Mw) of about 5,000 to about 500,000. In some examples, the binder has an average molecular weight (Mw) ranging from about 100,000 to about 300,000. In some other examples, the binder has an average molecular weight of about 250,000. The average particle diameter of the latex binder can be from about 10 nm to about 10 μm; in some other examples, from about 100 nm to about 5 μm; and, in yet other examples, from about 500 nm to about 0.5 μm. The particle size distribution of the binder is not particularly limited, and either binder having a broad particle size distribution or binder having a mono-dispersed particle size distribution may be used. The binder may include, but is in no way limited to latex resins sold under the name Hycar® or Vycar® (from Lubrizol Advanced Materials Inc.); Rhoplex® (from Rohm & Hass company); Neocar® (from Dow Chemical Comp); Aquacer® (from BYC Inc) or Lucidene® (from Rohm & Haas company).

In some examples, the polymeric binder is selected from natural macromolecule materials such as starches, chemical or biological modified starches and gelatins. The binder could be a starch additive. The starch additive may be of any type, including but not limited to oxidized, ethylated, cationic and pearl starch. In some examples, the starch is used in an aqueous solution. Suitable starches that can be used herein are modified starches such as starch acetates, starch esters, starch ethers, starch phosphates, starch xanthates, anionic starches, cationic starches and the like which can be derived by reacting the starch with a suitable chemical or enzymatic reagent. In some examples, the starch additives can be native starch, or modified starches (enzymatically modified starch or chemically modified starch). In some other examples, the starches are cationic starches and chemically modified starches. In yet some other examples, the starch is used in a form of nano-sized dispersed slurry. Useful starches may be prepared by known techniques or obtained from commercial sources. Examples of suitable starches include Penford Gum-280 (commercially available from Penford Products), SLS-280 (commercially available from St. Lawrence Starch), the cationic starch CatoSize 270 (from National Starch) and the hydroxypropyl No. 02382 (from Poly Sciences). In some examples, a suitable size press/surface starch additive is 2-hydroxyethyl starch ether, which is commercially available under the tradename Penford®Gum 270 (available from Penford Products). In some other examples, a suitable starch is nano sized bio-starch, which is commercially available under the tradename Ecosphere 2202®.

In some examples, due to strong tendency of re-agglomeration of the nano particles due to change of ionic strength, the binder is a non-ionic binder. Examples of such binders are commercially available, for example, from Dow Chemical Inc. under the tradename Aquaset® and Rhoplex emulsions, or are polyvinyl alcohol commercially available from Kuraray American Inc. under the tradename Poval®, Mowiol® and Mowiflex®.

In addition to the above-described components, the pre-treatment composition might also contain other components or additives, as necessary, to carry out the required mixing, coating, manufacturing, and other process steps, as well as to satisfy other requirements of the finished product, depending on its intended use. The additives include, but are not limited to, one or more of rheology modifiers, thickening agents, cross-linking agents, surfactants, defoamers, optical brighteners, dyes, pH controlling agents or wetting agents, and dispersing agents, for example. The total amount of additives, in the composition for forming the pre-treatment composition, can be from about 0.1 wt % to about 10 wt % or from about 0.2 wt % to about 5 wt %, by total dry weight of the pre-treatment composition.

The pre-treatment compositions are prepared in a liquid carrier that is used to disperse or solubilize coating composition components. The liquid carrier can be removed, at least in part, from the final product (the printable recording media) once the pre-treatment composition is applied to the substrate, or can include compounds that remain as solids when a portion of the carrier is removed, through drying. The liquid carrier can include one or more of water, co-solvents, surfactants, viscosity modifying agents, inorganic compounds, pH control agents, deformers, or the like. The primary function of the carrier is to dissolve and/or carry the solids or other components that are to remain on the media substrate as a coating, and for example, provide a carrier that will suitably carry all the components in the composition and help them uniformly distribute on the media surface. There is no specific limitation on selection of the carrier components, as long as the carrier as a whole has the function described above. In some examples, the pre-treatment composition comprises a liquid carrier that includes water.

The composition or pre-treatment composition of the present disclosure can be considered as a coating composition since it can be applied to various media to improve, for example, printing characteristics and attributes of an image. In some examples, the pre-treatment composition is a coating composition that is going to be applied to a media substrate.

The present disclosure further refers to a printable recording media that comprises a media substrate and a pre-treatment composition (or coating composition). Such pre-treatment composition comprises aggregated nano-sized inorganic pigment particles, polymeric organic particles having particles size in a ratio of 100:1 to 1000:1 by comparison with the size of aggregated nano-sized inorganic pigment particles, an ink absorber and a polymeric binder. The pre-treatment composition is applied to a media substrate in order to form a printable recording media on, at least, one side of the substrate. In some examples, the pre-treatment composition is applied to an “uncoated” substrate. By “uncoated”, it is meant herein that the media substrate has not been treated or coated by any composition and that the pre-treatment composition is applied directly on the substrate that constitutes the media.

As illustrated in FIG. 1, the printable media (100) contains a substrate (110) that supports pre-treatment composition or coating (120) and that acts as a bottom substrate layer or supporting base. Such substrate, which can also be called base print media substrate or base substrate or supporting substrate, contains a material that serves as a base upon which the pre-treatment composition will be applied in order to form a coating layer. The substrate provides integrity for the resultant printable media. The amount of the pre-treatment composition, on the media, in the dry state, is, at least, sufficient to hold all of the ink that is to be applied to the media. The basis weight of the print media substrate is dependent on the nature of the application of the printable recording media where lighter weights are employed for magazines, books and tri-folds brochures and heavier weights are employed for post cards and packaging applications, for example. The substrate can have a basis weight of about 60 grams per square meter (g/m² or gsm) to about 400 gsm, or about 100 gsm to about 250 gsm.

In some examples, the substrate is a paper base substrate. The media substrate can also be a photo-base paper, an uncoated plain paper or a plain paper having a porous coating, such as a calendared paper, an un-calendared paper, a cast-coated paper, a clay coated paper, or a commercial offset paper. The photobase may be a paper that is coated by co-extrusion with a high- or low- density polyethylene, polypropylene, or polyester on both surfaces of the paper.

The substrate may include any materials which can support a coating composition, for example, natural materials (such as a base including cellulose fibers) or synthetic material, (such as a base including synthetic polymeric fibers) or non-fabric materials (such as a polymeric film) or a mixture of them. The substrate material has good affinity and good compatibility for the ink that is applied to the material. Examples of substrates include, but are not limited to, natural cellulosic material, synthetic cellulosic material (such as, for example, cellulose diacetate, cellulose triacetate, cellulose propionate, cellulose butyrate, cellulose acetate butyrate and nitrocellulose), material including one or more polymers such as, for example, polyolefins, polyesters, polyamides, ethylene copolymers, polycarbonates, polyurethanes, polyalkylene oxides, polyester amides, polyethylene terephthalate, polyethylene, polystyrene, polypropylene, polycarbonate, polyvinyl acetal, polyalkyloxazolines, polyphenyl oxazolines, polyethylene-imines, polyvinyl pyrrolidones, and combinations of two or more of the above. The media substrate can be a paper base including paper, cardboard, paperboard, paper laminated with plastics, and paper coated with resin. The substrate may include polymeric binders. Such polymeric binder may be included, for example, when non-cellulose fibers are used.

In some examples, the substrate is a cellulose based substrate, meaning thus that it contains cellulose. The cellulose base could be made from pulp stock containing a fiber ratio (hardwood fibers to softwood fibers) of 70:30. The hardwood fibers have an average length ranging from about 0.5 mm to about 1.5 mm. These relatively short fibers improve the formation and smoothness of the base. Suitable hardwood fibers can include pulp fibers derived from deciduous trees (angiosperms), such as birch, aspen, oak, beech, maple, and eucalyptus. The hardwood fibers may be bleached or unbleached hardwood fibers. Rather than virginal hardwood fibers, other fibers with the same length, up to 20% of total hardwood fiber content, can be used as the hardwood fiber. The other fibers may be recycled fibers, non-deinkable fibers, unbleached fibers, synthetic fibers, mechanical fibers, or combinations thereof. The softwood fibers have an average length ranging from about 2 mm to about 7 mm. These relatively long fibers improve the mechanical strength of the base. Suitable softwood fibers can include pulp fibers derived from coniferous trees (gymnosperms), such as varieties of fir, spruce, and pine (e.g., loblolly pine, slash pine, Colorado spruce, balsam fir, and Douglas fir). The fibers may be prepared via any known pulping process, such as, for example, chemical pulping processes. Two suitable chemical pulping methods include the kraft process and the sulphite process.

The fibers of the substrate material may be produced from chemical pulp, mechanical pulp, thermal mechanical pulp, chemical mechanical pulp or chemical thermo-mechanical pulp. Examples of wood pulps include, but are not limited to, Kraft pulps and sulfite pulps, each of which may or may not be bleached. The substrate may also include non-cellulose fibers. The pulp used to make the cellulose base may also contain up to 10 wt % (with respect to total solids) of additives. Suitable additives may be selected from a group consisting of a dry strength additive, wet strength additive, a filler, a retention aid, a dye, an optical brightening agent (i.e., optical brightener), a surfactant, a sizing agent, a biocide, a defoamer, or a combination thereof.

The pre-treatment composition or coatings according to the present disclosure can be useful for a number of different types of media. However, it is particularly beneficial when used with aqueous-based inkjet inks to print upon porous commercial media. Porous commercial media is sometimes referred to as “open cell” commercial media because the surface is porous and tends to readily absorb ink. One example of such as commercial media is known as kraft liner paper made of “Kraft” pulp. Such kraft liner papers are produced from a chemical pulp produced in a “kraft process” or a “sulfate process.” With this process, wood is converted into wood pulp after removing lignin using chemical treatment. This provides a paper having an excellent strength and can be usable in a number of applications including wrapping papers, corrugated fiberboard, and packaging papers. Open cell paper may be bleached to provide a white appearance. Formulating aqueous inkjet ink for printing directly on standard open cell papers can be challenging. The use of the present pre-treatment coatings provide a treated surface that can receive inkjet inks and provide a print that is durable and of high color gamut.

In some examples, according to the principles described herein, a method of making a printable recording media comprising a substrate (110) and a coating layer (120) is provided. Such coating layer results from the application of the pre-treatment composition, as described herein, that comprises aggregated nano-sized inorganic pigment particles, polymeric organic particles having particles size in a ratio of 100:1 to 1000:1 by comparison with the size of aggregated nano-sized inorganic pigment particles, an ink absorber and a polymeric binder. The method of making a printable recording media comprises providing a media substrate; applying a pre-treatment composition to, at least, one side of said substrate, the pre-treatment composition including aggregated nano-sized inorganic pigment particles, polymeric organic particles having particles size in a ratio of 100:1 to 1000:1 by comparison with the size of aggregated nano-sized inorganic pigment particles, an ink absorber and a polymeric binder; and drying the pre-treatment composition in order to obtain a coating layer and a printable recording media.

FIG. 3 is a flow chart of a method (200) for making the printable recording media according to the present disclosure. In this method, a media substrate is provided (201); a pre-treatment composition is applied to, at least, one side of the substrate (202). The pre-treatment composition is then dried (203) in order to obtain a coating layer that will form a printable recording media (204).

The pre-treatment composition is dried to remove the solvent present in the composition such that the coated matrix is reduced to an average thickness in the range of about 1 to about 8 micrometers. In some examples, the pre-treatment composition is applied at a basis weight of about 0.1 gsm to about 10 gsm on side of the media substrate. In some other examples, the pre-treatment composition will be applied at a basis weight of about 1 gsm to about 5 gsm, or at a basis weight of about 1 gsm to about 2 gsm on side of the media substrate.

In some examples, the pre-treatment composition is applied to the substrate (110) on one side (on the image receiving side) of the substrate. In some other examples, the pre-treatment composition is applied to both sides of the substrate (110) (on the image receiving side and on the backside).

The pre-treatment composition can be applied to the media substrate by using one of a variety of suitable coating methods such as, for example, blade coating, air knife coating, metering rod coating, size press, curtain coating, or another suitable technique. The blocking layer may be, for example, applied using a conventional off-line coater, or use an online surface sizing unit, such as a puddle-size press, film-size press, or the like. The puddle-size press may be configured as having horizontal, vertical, and inclined rollers. In another example, the film-size press may include a metering system, such as gate-roll metering, blade metering, Meyer rod metering, or slot metering. For some examples, a film-size press with short-dwell blade metering may be used as application head to apply coating solution. The non-contact coating method example, the spray coating, is also suitable for this application.

In some examples, after the coating step, the media might go through a drying process to remove water and other volatile components present in the coating layer and substrate. The drying pass may comprise several different drying zones, including, but not limited to, infrared (IR) dryers, hot surface rolls, and hot air floatation boxes. In some other examples, after the coating and drying steps, the coated web may receive a glossy or satin surface with a calendering or super calendering step. When a calendering step is desired, the coated product passes an on-line or off-line calender machine, which could be a soft-nip calender or a super-calender. The rolls, in the calender machine, may or may not be heated, and certain pressure can be applied to calendering rolls. In addition, the coated product may go through embosser or other mechanical roller devices to modify surface characteristics such as texture, smoothness, gloss, etc.

A calendering process can then be used to achieve the desired gloss or surface smoothness. Calendering is the process of smoothing the surface of the paper by pressing it between nips formed in a pair of rollers. The rollers can be metal hard roll, and soft roll covered with a resilient cover, such as a polymer roll. The resilient-surface roll adapts itself to the contours of the surface of the substrate and presses the opposite side of substrate evenly against the smooth-surface press roll. Any of a number of calendering devices and methods can be used. The calendering device can be a separate super-calendering machine, an on-line calendaring unit, an off-line soft nip calendaring machine, or the like. In some examples, the calendering is carried out at room temperature. In some examples, the calendering is carried out at a temperature ranging from about 50 to about 150° C. (metal roll surface temperature) and, in some other examples, from about 80 to about 110° C. The nip pressure can be any value between about 50 to about 500 KN/cm2.

The present disclosure refers to a printable recording media comprising a media substrate and a pre-treatment composition, applied to, at least, one side of said substrate, that comprises aggregated nano-sized inorganic pigment particles, polymeric organic particles having particles size in a ratio of 100:1 to 1000:1 by comparison with the size of aggregated nano-sized inorganic pigment particles, an ink absorber and a polymeric binder. The printable recording media can be considered as a coated printable recording media. The pre-treatment composition forms a coating layer on at least one side of the substrate. Such printable recording media can be used in printing method.

The method for producing printed images, or printing method, includes providing a printable recording media such as defined herein; applying an ink composition on the coating layer of the print media, to form a printed image; and drying the printed image in order to provide, for example, a printed image with enhanced quality. In some examples, the printing method for producing images is an inkjet printing method. By inkjet printing method, it is meant herein a method wherein a stream of droplets of ink is jetted onto the recording substrate or media to form the desired printed image. The ink composition may be established on the recording media via any suitable inkjet printing technique. Examples of inkjet method include methods such as a charge control method that uses electrostatic attraction to eject ink, a drop-on-demand method which uses vibration pressure of a Piezo element, an acoustic inkjet method in which an electric signal is transformed into an acoustic beam and a thermal inkjet method that uses pressure caused by bubbles formed by heating ink. Non-limitative examples of such inkjet printing techniques include thus thermal, acoustic and piezoelectric inkjet printing. In some examples, the ink composition is applied onto the recording media using inkjet nozzles. In some other examples, the ink composition is applied onto the recording method using thermal inkjet printheads.

In some examples, the printing method as described herein prints on one-pass only. The paper passes under each nozzle and printhead only one time as opposed to scanning type printers where the printheads move over the same area of paper multiple times and only a fraction of total ink is used during each pass. The one-pass printing puts 100% of the ink from each nozzle/printhead down all at once and is therefore more demanding on the ability of the paper to handle all of the ink in a very short amount of time.

As mentioned above, a print media in accordance with the principles described herein may be employed to print images on one or more surfaces of the print media. In some examples, the method of printing an image includes depositing ink that contains particulate colorants. A temperature of the print media during the printing process is dependent on one or more of the nature of the printer, for example.

The printed image may be dried after printing. The drying stage may be conducted, by way of illustration and not limitation, by hot air, electrical heater or light irradiation (e.g., IR lamps), or a combination of such drying methods. In order to achieve best performances, it is advisable to dry the ink at a maximum temperature allowable by the print media that enables good image quality without deformation. Examples of a temperature during drying are, for example, from about 60° C. to about 205° C., or from about 120° C. to about 180° C. The printing method may further include a drying process in which the solvent (such as water), that can be present in the ink composition, is removed by drying. As a further step, the printable recording media can be submitted to a hot air drying systems. The printing method can also encompass the use of a fixing agent that will retain with the pigment, present in the ink composition that has been jetted onto the media.

The present pre-treatment composition can be used in conjunction with an inkjet ink. Such inkjet inks may include a colorant dispersed or dissolved in an ink vehicle. As used herein, “liquid vehicle” or “ink vehicle” refers to the liquid fluid in which a colorant is placed to form an ink. Ink vehicles are well known in the art, and a wide variety of ink vehicles may be used with the systems and methods of the present disclosure. Such ink vehicles may include a mixture of a variety of different agents, including, surfactants, solvents, co-solvents, anti-kogation agents, buffers, biocides, sequestering agents, viscosity modifiers, surface-active agents, water, etc. Though not part of the liquid vehicle per se, in addition to the colorants, the liquid vehicle can carry solid additives such as polymers, latexes, UV curable materials, plasticizers, etc. The colorant discussed herein can include a pigment and/or dye. As used herein, “dye” refers to compounds or molecules that impart color to an ink vehicle. As such, dye includes molecules and compounds that absorb electromagnetic radiation or certain wavelengths thereof. For example, dyes include those that fluoresce and those that absorb certain wavelengths of visible light. Furthermore, as used herein, “pigment” generally includes pigment colorants, magnetic particles, aluminas, silicas, and/or other ceramics, organo-metallics or other opaque particles. In one example, the colorant can be a pigment. Ink vehicle formulations can include water, and can further include co-solvents present in total at from 0.1 wt % to 40 wt %, depending on the jetting architecture, though amounts outside of this range can also be used. Further, additional non-ionic, cationic, and/or anionic surfactants can be present, ranging from 0.01 wt % to 10 wt %. In addition to the colorant, the balance of the formulation can be purified water, and the inkjet ink can optionally include a latex.

### EXAMPLES

### Ingredients:

TABLE 1

| Ingredient name | Nature of the ingredient | supplier |
|---|---|---|
| Calcium Chloride | Ink absorber | Sigma-Aldrich |
| Disperal ® HP-14 | aggregated nano-sized | Sasol Co. |
| | inorganic pigment particle | |
| Raycat ®78 | polymeric organic particle | Specialty Polymer |
| Rhoplex ®K3 | polymeric organic particle | Dow |
| Hydrocarb ® H60/90 | inorganic pigment particulates | Omya Inc. |
| Dynwet ®800 | surfactant | BYK Inc. |
| Mowiol ® 40-88 | polyvinyl alcohol (PVA) | Kurraray |
| | binder | |

### Example 1

### Pre-Treatment Formulations

Different formulations of pre-treatment compositions are prepared by mixing the different ingredients as listed below in Table 2. The numbers represent the parts of each component present in each layer based on 100 parts of dry part of inorganic pigments. Exp. 4, 5 and 6 are formulation of the pre-treatment compositions according to the present disclosure. Exp. 1, 2 and 3 are formulation of comparative examples.

TABLE 2

| | Exp. 1 | Exp. 2 | Exp. 3 | | | |
|---|---|---|---|---|---|---|
| Ingredients | (comp.) | (comp.) | (comp.) | Exp. 4 | Exp. 5 | Exp. 6 |
| CaCl₂ solution | — | — | 5 | 5 | 5 | 5 |
| Disperal ® | 100 | 100 | — | 100 | 100 | 100 |
| HP-14 | | | | | | |
| Hydrocarb ® | — | — | 100 | — | — | — |
| H90 | | | | | | |
| Raycat ® 78 | — | 5 | 5 | 5 | 10 | — |
| Roplex ® K3 | — | — | — | — | — | 5 |
| Mowiol ® | 10 | 10 | 10 | 10 | 10 | 10 |
| 40-88 | | | | | | |
| Dynwet ® 800 | 1.0 | 1.0 | 1.0 | 1.0 | 1.0 | 1.0 |

### Example 2

### Printable Recording Media

A base substrate (i.e. commercial uncoated printing paper) having a basis weight of 146 gsm is used. The substrate is made of fiber pulp that contains about 80% hardwood fibers and 20 about % soft wood fibers. The substrate is made of chemical pulped fibers and recycled pulped fibers. The substrate also contains about 12 wt % inorganic fillers (calcium carbonates) that are added to the fiber structure of the raw base at wet end. The pre-treatment compositions, as illustrated in the Table 1, are applied to the substrate using a Mayer rod as the metering device and dried. A glossing treatment is carried out by using a metal/rubber pressured roll pair. The printable recording media are then calendered through a two-nip soft nip calendering machine (at 100 kN/m, 54.4° C. (130° F.)).

An identical image sequence is then printed on the printable recording media samples treated with the pre-treatment formation (Examples 1 to 6). The different recording media samples are evaluated for different parameters and properties: image quality, durability of the printed image, dry time and gloss. Such parameters and properties are expressed in Table 3 below.

The image quality includes the evaluation of the Color Gamut, bleeding, coalescence, and print mottle. Gamut Measurement (Gamut) represents the amount of color space covered by the ink on the media. Gamut volume is calculated using L*a*b* values of 8 colors (cyan, magenta, yellow, black, red, green, blue, white) measured with an X-RITE®939 Spectro-densitometer (X-Rite Corporation), using D65 illuminant and 2o observer angle. L*min value testing is carried out on a black printed area and is measured with an X-RITE®939 Spectro-densitometer, using D65 illuminant and 2° observer angle. This measure determines how “black” the black color is. Bleed testing is carried out with a bleed stinger pattern. 1016 micron lines (or 40 mil, where 1 mil= 1/1000th of an inch) of cyan, magenta, yellow, black, red, green, blue inks, passing through solid area fills of each color, are printed and scanned. The bleed is evaluated visually for acceptability.

The dry time is evaluated by applying an A4 size uncoated paper (such as HP Bright white® paper) on top of each fresh printing images with all primary and secondary color. A 4 lb roller is rolling three time on top of the A4 paper, then a timer is started. The paper is removed every minute until the time that has no ink get transferred to the A4 paper from the printing image. This time is recorded as dry time of the media.

The image durability is evaluated by using an abrasion scrub tester (per ASTM D4828 method). Both print samples and test probes are immerse in water or in an organic solvent (409 All Purpose Cleaner®). The amount of ink remaining on the printed media is determined by measurement of the ink OD transferred on test probe. Good adhesion, upon immersion, will tend not to transfer ink from a printed image and the black optical density (KOD) will be maintained (A high OD indicates a worse ink adhesion).

The Gloss level is determined using a gloss-meter (such as the BYK Tri-Gloss-meter). The gloss level is reported as percentage per giving measuring angle such as 60 degree angle gloss. The nip pressure, refer herein to the pressure applied during the calender process.

The results of these tests are illustrated in Table 3. According to such results, it can be seen that the printable recording media having the pre-treatment composition according to the present disclosure provides the best overall performances.

TABLE 3

| | Gloss | Gloss | | | |
|---|---|---|---|---|---|
| | (number of | (500 PSI nip | | | Image |
| | nip pressure) | pressure) | Image Quality | Dry time | durability |
| Exp. 1 | 8 | 14 | Poor (low gamut, poor | Good | Good |
| (comp.) | | | bleed, high mottle) | | |
| Exp. 2 | 12 | 23 | Poor (low gamut, poor | Good | Average |
| (comp.) | | | bleed, high mottle) | | |
| Exp. 3 | 15 | 25 | Poor (bleed) | Poor | Poor in wet |
| (comp.) | | | | | smudge |
| Exp. 4 | 13 | 24 | Good | Good | Good |
| Exp. 5 | 12 | 35 | Good | Good | Good |
| Exp. 6 | 11 | 30 | Good | Good | Good |

1. A pre-treatment composition comprising aggregated nano-sized inorganic pigment particles, polymeric organic particles having particles size in a ratio of 100:1 to 1000:1 by comparison with the size of aggregated nano-sized inorganic pigment particles, an ink absorber and a polymeric binder.

2. The pre-treatment composition of claim 1 that further comprises inorganic spacers.

3. The pre-treatment composition of claim 2 wherein the inorganic spacers are particles that have an average particle size in the range of about 0.1 to about 25 micrometers.

4. The pre-treatment composition of claim 1 wherein the aggregated nano-sized inorganic pigment particles have an average particle size in the range of about 1 to about 500 nanometers.

5. The pre-treatment composition of claim 1 wherein the aggregated nano-sized inorganic pigment particles are present in an amount representing from about 10 wt % to about 95 wt % of the total weight of the pre-treatment composition.

6. The pre-treatment composition of claim 1 wherein the aggregated nano-sized inorganic pigment particles are metal oxide or complex metal oxide particles.

7. The pre-treatment composition of claim 1 wherein the aggregated nano-sized inorganic pigment particles are titanium dioxide, aluminum oxide or silicon dioxide.

8. The pre-treatment composition of claim 1 wherein the aggregated nano-sized inorganic pigment particles are modified with a surface treatment containing organosilane and aluminum chlorohydrate.

9. The pre-treatment composition of claim 1 wherein the polymeric organic particles are present in the pre-treatment composition in an amount representing from about 5 to about 20 parts based on 100 parts of aggregated nano-sized inorganic pigment particles.

10. The pre-treatment composition of claim 1 wherein the polymeric organic particles are polyolefin particles, dispersion or emulsion of polyolefin particles, acrylic emulsion or polyacrylic emulsion.

11. The pre-treatment composition of claim 1 wherein the ink absorber is a water soluble divalent or multi-valent metal salt.

12. The pre-treatment composition of claim 1 wherein the ink absorber is calcium chloride and/or calcium acetate.

13. The pre-treatment composition of claim 1 wherein the polymeric binder is present, in the pre-treatment composition, in an amount representing from about 2 to about 25 dry parts based on 100 parts of aggregated nano-sized inorganic pigment particles.

14. A printable recording media comprising:
a. a media substrate and
b. a pre-treatment composition applied to, at least, one side of said substrate, that comprises aggregated nano-sized inorganic pigment particles, polymeric organic particles having particles size in a ratio of 100:1 to 1000:1 by comparison with the size of aggregated nano-sized inorganic pigment particles, an ink absorber and a polymeric binder.

15. A method of making a printable recording media comprising:
a. providing a media substrate;
b. applying a pre-treatment composition to, at least, one side of said substrate, that includes aggregated nano-sized inorganic pigment particles, polymeric organic particles having particles size in a ratio of 100:1 to 1000:1 by comparison with the size of aggregated nano-sized inorganic pigment particles an ink absorber; and a polymeric binder;
c. and drying the pre-treatment composition in order to obtain a coating layer and a printable recording media.
